(19) United States
(12) Patent Application Publication
(10) Pub. No.: US 2009/0015425 A1
(43) Pub. Date: Jan. 15, 2009

(54) CAMERA OF AN ELECTRONIC DEVICE USED AS A PROXIMITY DETECTOR

(75) Inventors: Fredrik Palmqvist, Staffanstorp (SE); Goran W. Schack, Ahus (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/777,301

(22) Filed: Jul. 13, 2007

(51) Int. Cl. G08B 21/00

(52) U.S. Cl. 340/686.6

(57) ABSTRACT

A portable electronic device includes an optical input device operative to capture image data, at least one subsystem for controlling at least one operating parameter of the electronic device, and a proximity detection circuit operatively coupled to said optical input device and said subsystem. The proximity detection circuit is operative to determine if an object is within a predetermined distance of the electronic device based on the captured image data and, based on the determination, command the at least one subsystem to change the least one operating parameter.

### TECHNICAL FIELD OF THE INVENTION

The present invention relates generally to electronic devices, such as electronic devices for engaging in voice communications. More particularly, the invention relates to a device and method for using a camera to simulate a proximity switch in electronic devices.

### DESCRIPTION OF THE RELATED ART

Mobile and/or wireless items of electronic devices are becoming increasingly popular and are now in wide-spread use. In addition, the features associated with certain types of electronic devices have become increasingly diverse. To name a few examples, many electronic devices include cameras, text messaging capability, Internet browsing functionality, electronic mail capability, video playback capability, audio playback capability, image display capability, navigation capability, and hands-free headset interfaces.

New features for electronic devices are constantly being developed and brought to market. Some of these new features may be implemented purely via firmware, examples of which include new and improved ways of managing contacts, new video features, new text message features, etc. Since such features are implemented in firmware, they do not add to the size or weight of the electronic device.

Other features, however, may require additional hardware in order to implement the new feature, e.g., the inclusion of new wireless communication functionality may require new radio hardware. The addition of hardware, however, requires physical space within the electronic device and, therefore, may contribute to an increase in size and weight of the electronic device. The added hardware also increases the cost of the electronic device.

### SUMMARY

As advances in technology continue, consumers demand increased levels of performance from electronic devices, while at the same time demanding a reduction in the size and weight of these devices. These demands, however, create a “catch-22”, wherein additional features implemented in the electronic device tend to increase the size and weight of the electronic device. Conversely, decreasing the size and/or weight of the electronic device tends to limit the features (particularly features that require additional hardware) that may be implemented in the electronic device.

The present invention enables a commonly found feature of electronic devices, in addition to performing its primary function, to perform secondary functions commonly implemented via additional hardware. More particularly, an optical input function (e.g., a camera function) of the electronic device, for example, in addition to performing image functions such as obtaining snap shots and/or videos (e.g., movie clips and/or videos used during video phone calls), also may be used to detect a proximity of an object relative to the electronic device. Such proximity detection can include, for example, detection of the electronic device relative to a user of the device, an orientation of parts of the electronic device relative to each other (e.g., whether or not the electronic device open or closed), or a storage condition of the device (e.g., whether or not the device is placed within a carrying case). This information then can be used to control the operation of other features of the electronic device, such as a back light of a display, audio output signals and/or levels provided to speakers, etc. Moreover, proximity detection via optical input enables at least one additional component (e.g., a proximity switch) to be removed from the electronic device, thereby reducing cost and weight of the electronic device.

According to one aspect of the invention, a portable electronic device includes: an optical input device operative to capture image data; at least one subsystem for controlling at least one operating parameter of the electronic device; and a proximity detection circuit operatively coupled to said optical input device and said subsystem, said proximity detection circuit operative to determine if an object is within a predetermined distance of the electronic device based on the captured image data and, based on the determination, command the at least one subsystem to change the least one operating parameter.

According to one aspect of the invention, the at least one subsystem includes audio circuitry operative to control a sound level output by the electronic device, and wherein the proximity detection circuit commands the subsystem to set a first sound level when the object is within the predetermined distance of the electronic device, and to set a second sound level different from the first sound level when the object is not within the predetermined distance of the electronic device.

According to one aspect of the invention, the at least one subsystem includes display circuitry operative to control visual data on a display of the electronic device, and wherein the proximity detection circuit commands the subsystem to disable video output on the display when the object is within the predetermined distance of the electronic device, and to enable video output when the object is not within the predetermined distance of the electronic device.

According to one aspect of the invention, the electronic device further comprises: a first part; a second part; a mechanical mechanism coupled to the first and second part and operable to position the first part in at least two different orientations relative to the second part, wherein said optical input device is arranged on the first part; and a characteristic marking arranged on the second part so as to be within a field of view of the optical input device when the first and second part are in a first orientation of the at least two orientations, and not within a field of view of the optical input device when the first and second part are in a second orientation of the at least two orientations.

According to one aspect of the invention, the characteristic marking is at least one of a color or a pattern.

According to one aspect of the invention, the object is at least part of a user of the electronic device, and detection of the user limits a volume output of the electronic device to a predetermined level.

According to one aspect of the invention, the device is a mobile telephone.

According to one aspect of the invention, the optical input device is a camera.

According to one aspect of the invention, the device is at least one of a pager, electronic organizer, personal digital assistant (PDA), portable communication apparatus, portable gaming device, or portable media player.

According to one aspect of the invention, the optical input device and/or proximity detection circuit are disabled when the electronic device is in a closed or standby mode.

According to one aspect of the invention, a distance of the object from the electronic device is determined based on a difference in intensity of adjacent pixels of the image data.

According to one aspect of the invention, a method for controlling at least one subsystem of a portable electronic device, said electronic device including an optical input device, includes: capturing image data via the optical input device; detecting if an object is within a predetermined distance of the electronic device based on the captured image data; and controlling the at least one subsystem based on whether or not the object is within the predetermined range of the electronic device.

According to one aspect of the invention, controlling includes limiting a sound output to a fraction of a requested sound output when the object is within the predetermined distance of the electronic device, and allowing the requested sound output when the object is not within the predetermined distance of the electronic device.

According to one aspect of the invention, controlling includes disabling a display of the electronic device when the object is within the predetermined distance of the electronic device, and enabling the display when the object is not within the predetermined distance of the electronic device.

According to one aspect of the invention, detecting includes detecting if a first part of the electronic device is within the predetermined range of a second part of the electronic device.

According to one aspect of the invention, detecting includes detecting if at least part of a user of the electronic device is within the predetermined range of the electronic device.

According to one aspect of the invention, the method further includes disabling capturing and/or detecting when the electronic device is in a closed or standby mode.

According to one aspect of the invention, detecting if the object is within a predetermined distance includes detecting a characteristic marking of the object, wherein if said characteristic mark is detected, concluding that the electronic device is in a closed or standby mode.

According to one aspect of the invention, the object is a carrying case of the electronic device.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a schematic view of a mobile telephone as an exemplary electronic device in accordance with an embodiment of the present invention.

FIG. 2 is a schematic block diagram of the relevant portions of the mobile telephone of FIG. 1 in accordance with an embodiment of the present invention.

FIG. 3 is a schematic view of an exemplary mobile telephone having a clamshell form factor.

FIG. 4 is a schematic diagram of a communications system in which the mobile telephone of FIG. 1 may operate.

FIGS. 5A and 5B illustrate variation in sound output based on a relative location of the mobile telephone in accordance with the invention.

FIG. 6 is a flow chart of an exemplary proximity detection function in accordance with the present invention.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smart phones, portable communication apparatus, portable gaming devices, portable media devices (video and/or audio), and the like.

In the present application, embodiments of the invention are described primarily in the context of a mobile telephone. However, it will be appreciated that the invention is not intended to be limited to the context of a mobile telephone and may relate to any type of appropriate electronic equipment.

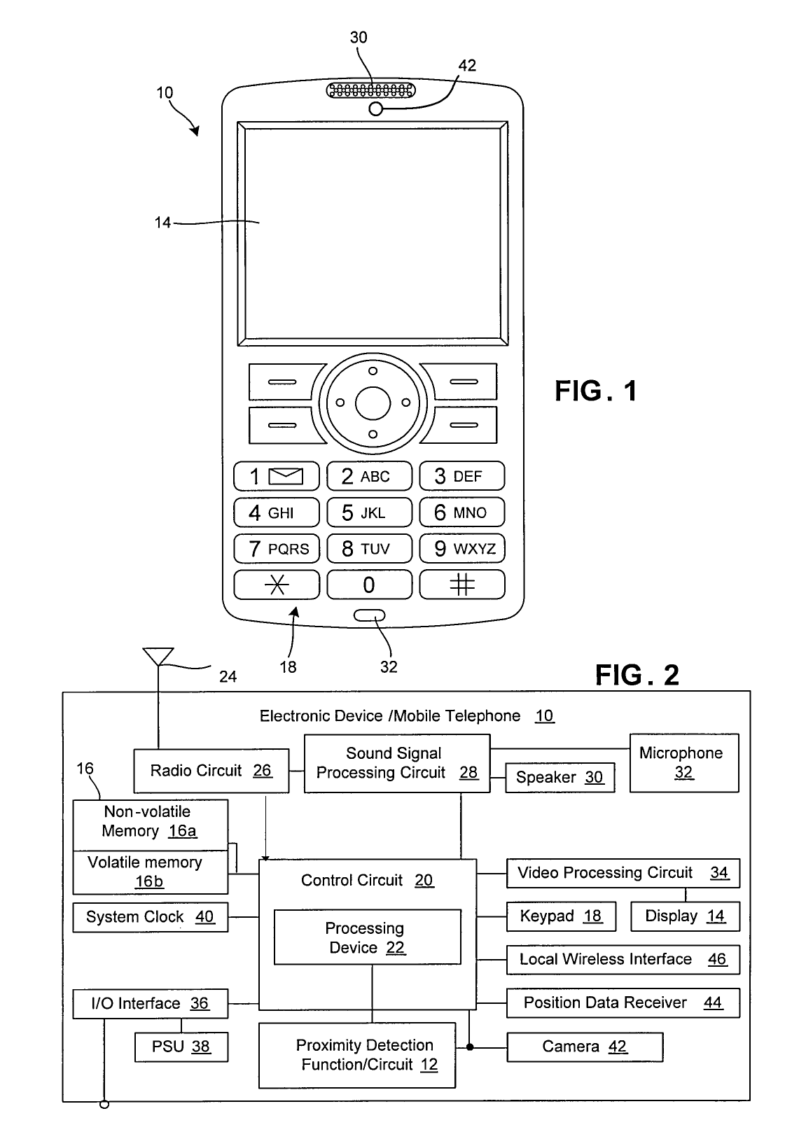

Referring initially to FIGS. 1 and 2, an electronic device 10 is shown. The electronic device 10 includes a proximity detection function 12 that is configured to automatically detect whether or not an object is within a predetermined distance or range of the electronic device, and to command various features of the electronic device based on the relative distance of the object. Additional details and operation of the proximity detection function 12 will be described in greater detail below. The proximity detection function 12 may be embodied as executable code that is resident in and executed by the electronic device 10. In one embodiment, the proximity detection function 12 may be a program stored on a computer or machine readable medium. The proximity detection function 12 may be a stand-alone software application or form a part of a software application that carries out additional tasks related to the electronic device 10.

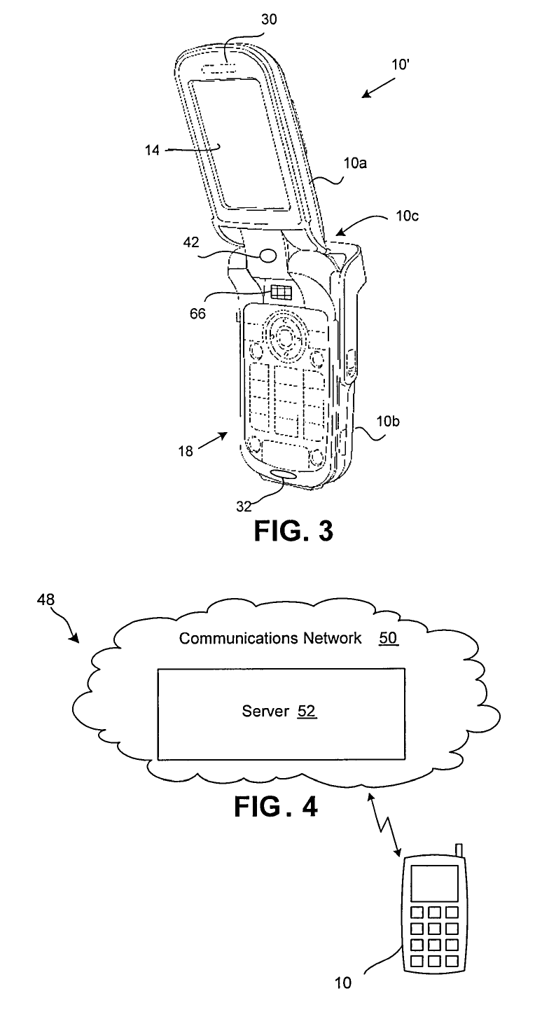

The electronic device of the illustrated embodiment is a mobile telephone and will be referred to as the mobile telephone 10. The mobile telephone 10 is shown as having a brick or block form factor, although other form factors, such as a “flip-open” form factor (e.g., a “clamshell” housing) or a slide-type form factor (e.g., a “slider” housing) also my be utilized. FIG. 3 illustrates an exemplary mobile telephone 10′ having a “flip-open” or “clamshell” housing. In this configuration, the mobile telephone 10′ includes a first part 10a coupled to a second part 10b via a mechanical connector 10c, such as a hinge or sliding mechanism, for example, wherein the first part 10a may be moved relative to the second part 10b so as to change a shape or profile of the mobile telephone 10′.

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 2) of the mobile telephone 10. The display 14 may be used to present images, video and other graphics to the user, such as photographs, mobile television content and video associated with games.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages (e.g., a text message is commonly referred to by some as “an SMS,” which stands for short message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein.

The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10.

The memory 16 may include a read only memory area that is implemented using nonvolatile memory 16a, and a random access or system memory area that is implemented using volatile memory 16b. As will be appreciated, nonvolatile memory tends not to lose data storage capability upon loss of power and is typically used to store data, application code, files and so forth. The nonvolatile memory 16a may be implemented with a flash memory, for example. The flash memory may have a NAND architecture, but other flash memory architectures, such as a NOR architecture, may be used. As will be appreciated, volatile memory tends to lose data storage capability upon loss of power and is typically used to store data for access by the processing device 22 during the execution of logical routines. The volatile memory 16b may be a random access memory (RAM). The RAM may be a synchronous dynamic random access memory (SDRAM), for example, but other RAM architectures that utilize memory blocks may be used. Data may be exchanged between the nonvolatile memory 16a and the volatile memory 16b as is conventional. The nonvolatile memory 16a and the volatile memory 16b may be sized as is appropriate for the mobile telephone 10 or other electronic device in which the memory 16 is used.

In addition, the processing device 22 may execute code that implements the proximity detection function 12. It will be apparent to a person having ordinary skill in the art of computer programming, and specifically in application programming for mobile telephones or other electronic devices, how to program a mobile telephone 10 to operate and carry out logical functions associated with the proximity detection function 12 based on the description herein. Accordingly, details as to specific programming code have been left out for the sake of brevity. Also, while the proximity detection function 12 is executed by the processing device 22 in accordance with a preferred embodiment of the invention, such functionality could also be carried out via dedicated hardware, firmware, software, or combinations thereof, without departing from the scope of the invention. Any of these implementations may be referred to as a proximity detection circuit 12 or simply a logic circuit.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream that is received by the radio circuit 28 or obtained by any other suitable method.

The mobile telephone 10 may further include one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 also may include a system clock 40 for clocking the various components of the mobile telephone 10, such as the control circuit 20. The control circuit 20 may, in turn, carry out timing functions, such as timing the durations of calls, generating the content of time and date stamps, and so forth.

The mobile telephone 10 may include a camera 42 for taking digital pictures, movies and/or conducting video phone calls. As will be appreciated, the location of the camera on the mobile telephone may be dependent on the type of camera (e.g., a video phone camera may be on the front side of the phone, while a snapshot camera may be on the backside of the phone). Image and/or video files corresponding to the pictures and/or movies may be stored in the memory 16. The camera 42 also may be used in conjunction with the proximity detection function 12, as described in more detail below.

The mobile telephone 10 also may include a position data receiver 44, such as a global positioning system (GPS) receiver, Galileo satellite system receiver or the like.

The mobile telephone 10 also may include a local wireless interface 46, such as an infrared transceiver and/or an RF interface (e.g., a Bluetooth interface, WiFi interface, etc.), for establishing communication with an accessory, another mobile radio terminal, a computer or another device. For example, the local wireless interface 46 may operatively couple the mobile telephone 10 to a headset assembly (e.g., a PHF device) in an embodiment where the headset assembly has a corresponding wireless interface.

With additional reference to FIG. 4, the mobile telephone 10 may be configured to operate as part of a communications system 48. The system 48 may include a communications network 50 having a server 52 (or servers) for managing calls placed by and destined to the mobile telephone 10, transmitting data to the mobile telephone 10 and carrying out any other support functions. The server 52 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices.

As will be appreciated, the server 52 may be configured as a typical computer system used to carry out server functions and may include a processor configured to execute software containing logical instructions that embody the functions of the server 52 and a memory to store such software.

Moving now to the proximity detection function/circuit 12 of FIG. 2, this circuit is operative to determine a distance of an object relative to the mobile telephone 10 based on optical data (e.g., whether or not an object is within a predetermined distance or range of the mobile telephone). The optical data may be image data, for example, obtained from the camera 42 of the mobile telephone 10. Based on the relative distance of the object, subsystems of the mobile telephone 10 can be set accordingly. In other words, subsystems may be enabled, disabled and/or adjusted based on whether or not an object is relatively near (e.g., 1 foot or less) the mobile telephone 10. As used herein, a subsystem or subsystems refer to hardware and/or software that provide specific functionality, such as sound input/output, video input/output, data input/output, etc. A non-limiting list of subsystems of the mobile phone 10 includes the display 14, keypad 18, sound signal processing circuit 28, speaker 30, microphone 32, video processing circuit 34, I/O interface 36, position data receiver 44, and local wireless interface 46, as well as the software that provides control signals for the respective systems.

Further, the proximity detection function/circuit 12 can replace one or more proximity switches of the mobile telephone 10. This can reduce the size, weight and cost of the mobile telephone 10.

In operation, the optical input device (e.g., the camera 42) can collect image data for the area surrounding the mobile telephone 10 in a continuous or periodic manner, or based on a state of the phone. For example, in a mobile telephone having a clamshell configuration (without a dedicated switch to detect if the phone is open or closed), data may be periodically collected and analyzed to determine the state of the phone (e.g., open or closed). If the proximity detection function/circuit 12 is used solely as an acoustic safety device (e.g., to protect a user from exposure to high volume levels), image data may be collected only when the phone is open. In such an embodiment, a separate switch would be needed to determine when the phone is in the open state (and thus enable collection of image data).

Regardless of how often or when the data is collected, once image data is obtained, it can be analyzed by the proximity detection function/circuit 12 so as to determine if an object is within a predefined distance from the mobile telephone. This determination may be based on a passive (e.g., analysis of the image itself) technique, for example.

A passive technique determines the distance to the object by computer analysis of the image itself. The proximity detection function/circuit 12, for example, can look at a strip of pixels in the image data and look at the difference in intensity among adjacent pixels. If the scene is out of focus, adjacent pixels have very similar intensities. The proximity detection function/circuit 12 then searches for the point where there is maximum intensity difference between adjacent pixels (e.g., by adjusting the camera's focus and reacquiring image data), which is the point of best focus. Based on this determination, an estimated distance of the object can be calculated.

As noted above, the detected object may be a user of the mobile telephone, or a portion of the mobile telephone itself (e.g., detecting if the phone is open or closed). Another example may be a phone that is placed within a carrying case or the like, wherein the detected object is the carrying case.

Once the distance of the object has been determined, subsystems of the mobile telephone 10 may be enabled and/or disabled, or settings of the subsystems can be altered to meet specific needs. For example, in detecting the presence of a user, an audio output level of the ring tone may be set accordingly. More specifically, if a user is not detected to be within a predetermined distance of the mobile telephone 10, then an audio output level of the ring tone may be set to 100% of a requested volume. However, if a user is detected within the predetermined distance of the mobile telephone 10, then the audio output level may be decreased by a preset amount (e.g., 25% of requested volume).

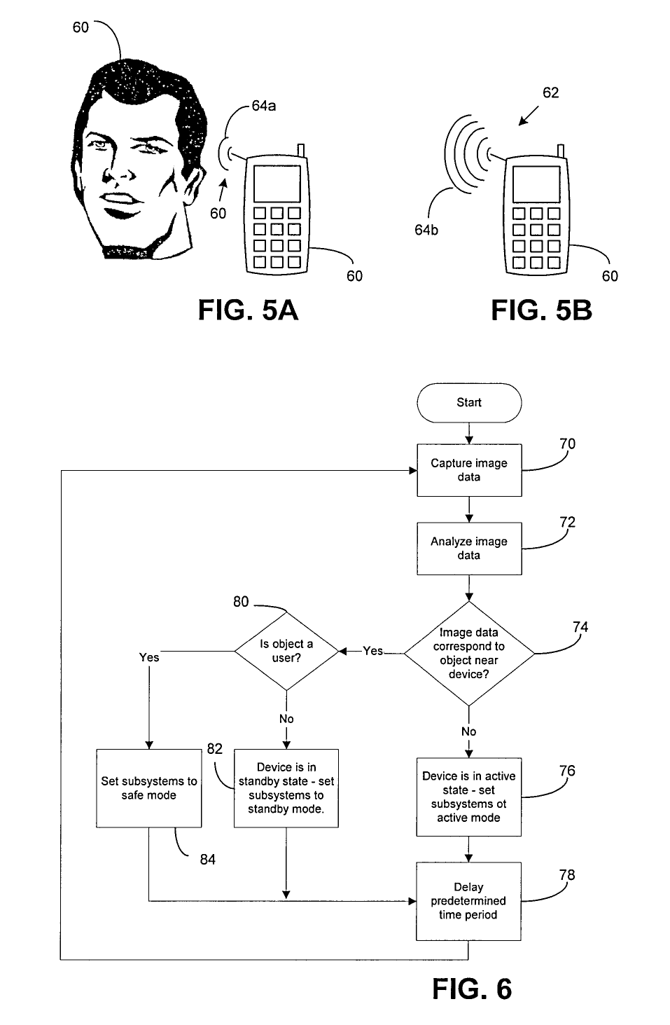

FIGS. 5A and 5B illustrate this scenario, wherein when a user 60 is near the mobile telephone 10, an audio output 62 of the mobile telephone 10 is set to a reduced level 64a (e.g., at a fraction of a requested level). This lower level is schematically shown by two sound bars originating from the mobile telephone 10. If a user is not near the mobile telephone 10, then the audio output 62 is set at the full or requested level 64b, which is schematically shown by the four sound bars originating from the mobile telephone 10. As will be appreciated, the limited or reduced audio output level 64a may be applied to ring tones or other notification signals, while not to voice communications.

By reducing the audio output level of notification signals (e.g., ring tones or the like), a safety device is effectively implemented that prevents the user from being subjected excessively loud audio. For example, if the mobile telephone 10 is near the user's ear (e.g., the user is lying down with the mobile telephone near his head, or if the user inadvertently places the phone against his ear as a call is incoming), then the ring tone output level will be reduced to a level that is safe for the user.

Similarly, and as noted above, the detected device may be a part of the mobile telephone itself, or of a carrying case of the mobile phone. Detection of part of the mobile telephone 10 (or of the case) may be equated as the mobile phone 10 being in an unused or standby state. Thus, subsystems, such as the display 14 (or backlight of the display), and the video processing circuit 34 can be disabled, thereby reducing power consumption. Further, the audio subsystem (e.g., the sound signal processing circuit 28 and associated hardware), may be commanded to output a requested sound level (e.g., 100% sound output), which can prevent missed calls, for example.

The proximity detection function/circuit 12 may be configured to operate in conjunction with one or more of the mobile telephone's subsystems. For example, the proximity detection function/circuit 12 may be exclusively configured to detect when the phone is near a user, and then to adjust the output sound level accordingly. In such a configuration, collection of image data may be disabled until the mobile telephone is in a predetermined state (e.g., the phone is in an open position). Alternatively, the proximity detection function/circuit 12 may be configured to operate with a plurality of subsystems, wherein optical data is periodically or continuously collected and analyzed. In operating with a number of different subsystems, it is preferable that the proximity detection function/circuit 12 determine the type of object that is near the mobile telephone so that the proper subsystem can be controlled.

For example, the proximity detection function/circuit 12 can be configured to detect particular characteristics in the object and, based on the presence or absence of such characteristics, conclude that a particular object is or is not within the predetermined distance of the mobile telephone 10. The characteristics can include, for example, a characteristic marking including one or more colors, color combinations and/or patterns. The patterns, for example, may be specific patterns (e.g., a cross hatch pattern, numbers, or simply a random pattern that the proximity detection function/circuit 12 identifies as being part of the object. FIG. 3 illustrates an exemplary characteristic marking 66 embodied as a cross hatch pattern, wherein the marking 66 is located opposite the camera 42. When the mobile telephone 10′ is closed, the camera 42 can collect image data for the characteristic marking 66. This can provide enhanced accuracy in determining the state (e.g., open or closed) of the mobile telephone 10′.

With additional reference to FIG. 6, illustrated are logical operations to implement an exemplary method for detecting the location of objects relative to the mobile telephone 10. The exemplary method may be carried out by executing an embodiment of the proximity detection function 12, for example. Thus, the flow chart of FIG. 6 may be thought of as depicting steps of a method carried out by the mobile telephone 10. Although FIG. 6 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The logical flow for the proximity detection function 12 may begin at block 70, wherein image data is captured by the camera 42. The captured image data may be temporarily stored in memory 16 via control circuit 20, or it may be directly provided to the proximity detection circuit 12. The image data may be conventional image data, such as is used in snapshots, movies or movie clips, and/or real time video data. Exemplary formats for image data include .jpeg, .bmp, .tiff, .gif, .avi, .mpeg, as well as other formats currently utilized or later developed.

At blocks 72 and 74 the captured image data is analyzed and a determination is made whether or not an object is within a predetermined distance of the mobile telephone 10. In determining if the object is within the predetermined distance of the mobile telephone 10, a passive range finding technique may be implemented. For example, the captured image data may be analyzed for differences in intensity among adjacent pixels. If the captured image data is an out of focus image, adjacent pixels have very similar intensities. A search can be performed for a point where there is maximum intensity difference between adjacent pixels, which is the point of best focus. Based on this determination, an estimated distance of the object can be calculated.

Once the distance to the object has been estimated, it can be compared to a predetermined value. If the distance is greater than the predetermined value, then it can be concluded that the object is not near the mobile telephone 10. Conversely, if the distance is less than or equal to the predetermined value, then it can be concluded that the object is near the mobile telephone 10.

If it is determined that an object is not within the predetermined distance of the mobile telephone 10, then it is concluded that the mobile phone 10 is in the active state (e.g., clamshell open, phone out of carrying case, etc.), and at block 76 subsystems of the mobile telephone are placed in an active state (e.g., the display 14 and video processing circuit 34 are activated, sound signal processing circuit 28 commands full requested sound levels, etc.). Then, at block 78, a predetermined delay is incorporated prior to repeating the image capture process. The delay, which can be in the range of a few milliseconds to about one second, reduces the amount of collected image data and, therefore, the load placed on the processing device 22. Delays greater than one second may be implemented, but system response may become unsatisfactory.

Moving back to block 74, if it is determined that an object is within the predetermined distance of the mobile telephone 10, then at block 80 it is determined if the object is a user of the mobile telephone 10 or some other object. A user may be identified, for example, based on characteristic patterns in the image data (e.g., a characteristic pattern of the human ear, for example). To increase the accuracy of the detection, a training mode may be implemented, wherein the user places the phone near his ear and/or face, and the image data is collected and stored in memory for later comparison.

In addition to identifying a user, the image data also may be analyzed to determine if the data corresponds to specific objects. For example, when a clamshell mobile telephone is in the closed configuration, a portion of the mobile telephone 10 that is opposite the camera 42 may be given distinctive features, such as a distinctive color and/or pattern. This distinctive color and/or pattern may be used to conclude that the object is part of the mobile telephone 10 and, thus, the clamshell mobile telephone is in the closed configuration. The above also applies to carrying cases for the mobile telephone 10.

If the object is not a user, then it is concluded that the mobile phone 10 is in a standby state (e.g., clamshell phone closed, or phone placed within a carrying case), as indicated at block 82. In the standby state, certain subsystems may be disabled (e.g., the display subsystem including the display backlight and associated circuitry may be disabled).

On the other hand, if the object is determined to be a user, then at block 84 safety features of the mobile telephone may be enabled. These safety features can include limiting a sound output level of the ring tone, for example, so as to prevent the user from inadvertently experiencing a loud ring tone (e.g., if a call is made to the mobile telephone 10 at the same time the user places the phone near his ear). Once the safety features have been enabled, then the method can move to block 78 as noted above.

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A portable electronic device, comprising:
an optical input device operative to capture image data;
at least one subsystem for controlling at least one operating parameter of the electronic device; and
a proximity detection circuit operatively coupled to said optical input device and said subsystem, said proximity detection circuit operative to determine if an object is within a predetermined distance of the electronic device based on the captured image data and, based on the determination, command the at least one subsystem to change the least one operating parameter.

2. The device according to claim 1, wherein the at least one subsystem includes audio circuitry operative to control a sound level output by the electronic device, and wherein the proximity detection circuit commands the subsystem to set a first sound level when the object is within the predetermined distance of the electronic device, and to set a second sound level different from the first sound level when the object is not within the predetermined distance of the electronic device.

3. The device according to claim 1, wherein the at least one subsystem includes display circuitry operative to control visual data on a display of the electronic device, and wherein the proximity detection circuit commands the subsystem to disable video output on the display when the object is within the predetermined distance of the electronic device, and to enable video output when the object is not within the predetermined distance of the electronic device.

4. The device according to claim 1, wherein the electronic device further comprises:
a first part;
a second part;
a mechanical mechanism coupled to the first and second part and operable to position the first part in at least two different orientations relative to the second part, wherein said optical input device is arranged on the first part; and
a characteristic marking arranged on the second part so as to be within a field of view of the optical input device when the first and second part are in a first orientation of the at least two orientations, and not within a field of view of the optical input device when the first and second part are in a second orientation of the at least two orientations.

5. The device according to claim 4, wherein the characteristic marking is at least one of a color or a pattern.

6. The device according to claim 1, wherein the object is at least part of a user of the electronic device, and detection of the user limits a volume output of the electronic device to a predetermined level.

7. The device according to claim 1, wherein the device is a mobile telephone.

8. The device according to claim 1, wherein the optical input device is a camera.

9. The device according to claim 1, wherein the device is at least one of a pager, electronic organizer, personal digital assistant (PDA), portable communication apparatus, portable gaming device, or portable media player.

10. The device according to claim 1, wherein the optical input device and/or proximity detection circuit are disabled when the electronic device is in a closed or standby mode.

11. The device according to claims 1, wherein a distance of the object from the electronic device is determined based on a difference in intensity of adjacent pixels of the image data.

12. A method for controlling at least one subsystem of a portable electronic device, said electronic device including an optical input device, comprising:
capturing image data via the optical input device;
detecting if an object is within a predetermined distance of the electronic device based on the captured image data; and
controlling the at least one subsystem based on whether or not the object is within the predetermined range of the electronic device.

13. The method according to claim 12, wherein controlling includes limiting a sound output to a fraction of a requested sound output when the object is within the predetermined distance of the electronic device, and allowing the requested sound output when the object is not within the predetermined distance of the electronic device.

14. The method according to claim 12, wherein controlling includes disabling a display of the electronic device when the object is within the predetermined distance of the electronic device, and enabling the display when the object is not within the predetermined distance of the electronic device.

15. The method according to claim 12, wherein detecting includes detecting if a first part of the electronic device is within the predetermined range of a second part of the electronic device.

16. The method according to claim 12, wherein detecting includes detecting if at least part of a user of the electronic device is within the predetermined range of the electronic device.

17. The method according to claim 12, further comprising disabling capturing and/or detecting when the electronic device is in a closed or standby mode.

18. The method according to claim 12, wherein detecting if the object is within a predetermined distance includes detecting a characteristic mark of the object, wherein if said characteristic mark is detected, concluding that the electronic device is in a closed or standby mode.

19. The method according to claim 19, wherein the object is a carrying case of the electronic device.
